(19) United States
(12) Patent Application Publication
(10) Pub. No.: US 2008/0152009 A1
(43) Pub. Date: Jun. 26, 2008

(54) Scaling the complexity of video encoding

(76) Inventors: Emrah Akyol, Los Angeles, CA (US); Debargha Mukherjee, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/643,130

(22) Filed: Dec. 21, 2006

(51) Int. Cl. H04N 7/32; H04N 7/26

(52) U.S. Cl. 375/240.16; 375/240.01; 375/E07.123

(57) ABSTRACT

Video encoding that enables fine-grained control over the complexity of motion estimation to meet encoding constraints includes scaling a set of complexity control parameters in response to an encoding constraint and encoding the video in response to the complexity control parameters.

### BACKGROUND

A video may include a series of images. A series of images when rendered in sequence may be perceived by a viewer as a motion picture. Each of the images in a video may be referred to as a video frame. A video frame may be arranged as an array of pixels each pixel having a corresponding set of data.

A video may include a relatively large amount of data. For example, a video having F video frames per second in which each video frame is an array of A by B pixels of X data bits each results in F times A times B times X bits per second of data. As a consequence, a video may consume relatively large amounts of storage space and large amounts of bandwidth of a communication channel.

Video encoding may be employed to reduce an amount of data in a video. For example, video encoding may be used to transform a series of video frames into a video bit stream having substantially less data than the original video frames while retaining much of the visual information in the original video frames.

Video encoding may be subject to one or more encoding constraints. One example of an encoding constraint is a bit rate constraint, e.g. a maximum or minimum bit rate in a video bit stream. Another example of an encoding constraint is an encoding time constraint, e.g. a maximum time that may be consumed in encoding all or part of a video.

Prior methods for meeting an encoding constraint include adjusting quantization parameters. For example, the quantization parameters used to encode video data may be used to increase or decrease the bit rate of an encoded video bit stream. Unfortunately, adjusting quantization parameters to meet an encoding constraint may excessively sacrifice the quality of an encoded video.

### SUMMARY OF THE INVENTION

Video encoding is disclosed that enables fine-grained control over the complexity of motion estimation to meet encoding constraints. Video encoding according to the present teachings includes scaling a set of complexity control parameters in response to an encoding constraint and encoding a video in response to the complexity control parameters.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows a video encoder according to the present teachings;

FIG. 2 shows a video encoder enforcing a constraint on a bit rate of an encoded video signal;

FIG. 3 shows a video encoder enforcing a constraint on an encoding time;

FIG. 4 shows a video encoder enforcing a constraint on an encoding time and a constraint on a bit rate;

FIG. 5 shows a controller and a mapper in one embodiment of a complexity controller;

FIG. 6 shows a video encoder enforcing a buffering constraint;

FIGS. 7a-7b show examples of ordered mode searches.

### DETAILED DESCRIPTION

FIG. 1 shows a video encoder 10 according to the present teachings. The video encoder 10 includes an encoder 18 and a complexity controller 20. The complexity controller 20 scales a set of complexity control parameters 52 in response to an encoding constraint 24. The encoder 18 generates a video signal 14 by encoding a set of raw video data, a series of video frames 12, in response to the scaled complexity control parameters 52.

The encoding constraint 24 may be any encoding constraint. One example of an encoding constraint is a bit rate constraint. Another example of an encoding constraint is an encoding time constraint, e.g. the encoding time of a macro-block or video frame, the time taken for motion estimation of a macro-block, etc. Another example of an encoding constraint is a buffering constraint. Another example of an encoding constraint is an amount of distortion in an encoded video signal. Another example of an encoding constraint is an amount of power consumption involved in encoding.

The complexity control parameters 52 in one embodiment are parameters for a fast motion estimation on macro-blocks. The complexity controller 20 may scale the complexity control parameters 52 to increase the complexity of fast motion estimation, thereby decreasing a bit rate of the video signal 14 and increasing coding time. The complexity controller 20 may scale the complexity control parameters 52 to decrease the complexity of fast motion estimation, thereby increasing a bit rate of the video signal 14 and decreasing coding time. The complexity controller 20 may scale the complexity control parameters 52 to meet a distortion constraint.

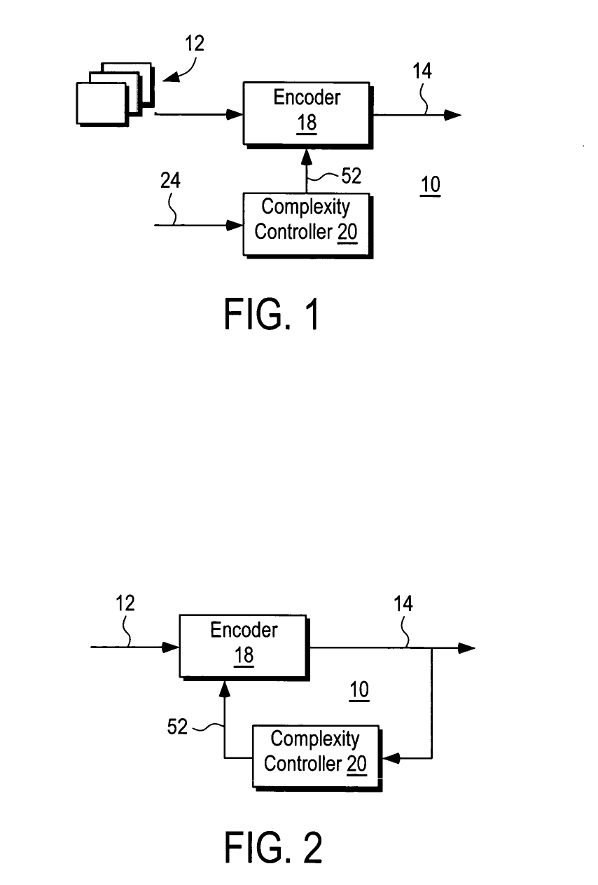

FIG. 2 shows the video encoder 10 enforcing a constraint on a bit rate of the video signal 14. The complexity controller 20 measures a bit rate for the video signal 14 and compares the measured bit rate to a target bit rate. If the measured bit rate of the video signal 14 is higher than the target bit rate then the complexity controller 20 scales the complexity control parameters 52 to reduce the bit rate of the video signal 14. If the measured bit rate of the video signal 14 is lower than the target bit rate then the complexity controller 20 scales the complexity control parameters 52 to increase the bit rate of the video signal 14. The complexity controller 20 may employ a sliding window control loop on sets of macro-blocks to ensure that a variation in the bit rate of the video signal 14 over time is relatively small.

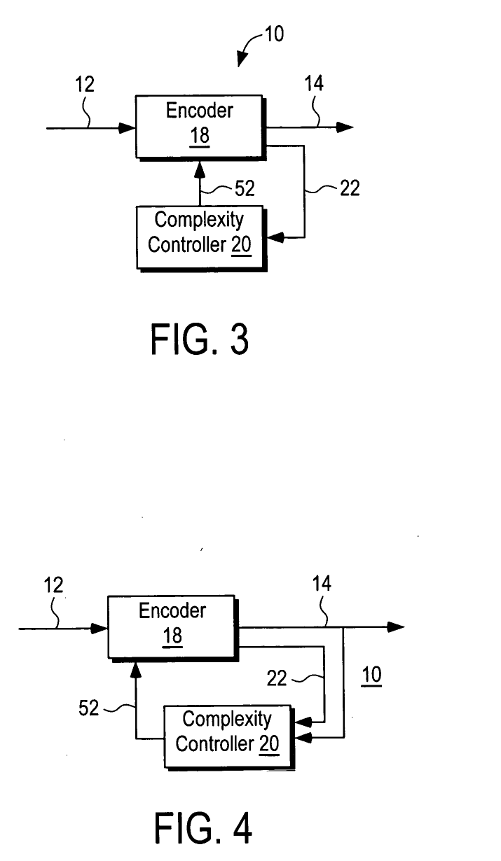

FIG. 3 shows the video encoder 10 enforcing a constraint on an encoding time. In this example, the encoding time of interest is a time taken to encode a macro-block of the video frames 12.

The complexity controller 20 obtains a timing signal 22 from the encoder 10. The timing signal 22 indicates a time consumed by the encoder 10 to encode a macro-block. The complexity controller 20 compares the timing signal 22 to a target encoding time. If the timing signal 22 indicates more time than the target encoding time then the complexity controller 20 scales the complexity control parameters 52 to decrease the encoding time. If the timing signal 22 indicates less time than the target encoding time then the complexity controller 20 scales the complexity control parameters 52 to increase the encoding time. The complexity controller 20 may employ a sliding window control loop to ensure that a variation in the encoding time over time is relatively small.

FIG. 4 shows the video encoder 10 enforcing a constraint on an encoding time and a constraint on a bit rate of the video signal 14. The complexity controller 20 obtains the timing signal 22 from the encoder 10 and measures a bit rate of the video signal 14. The complexity controller 20 scales the complexity control parameters 52 to simultaneously enforce a constraint on the bit rate of the video signal 14 and a constraint on an encoding time.

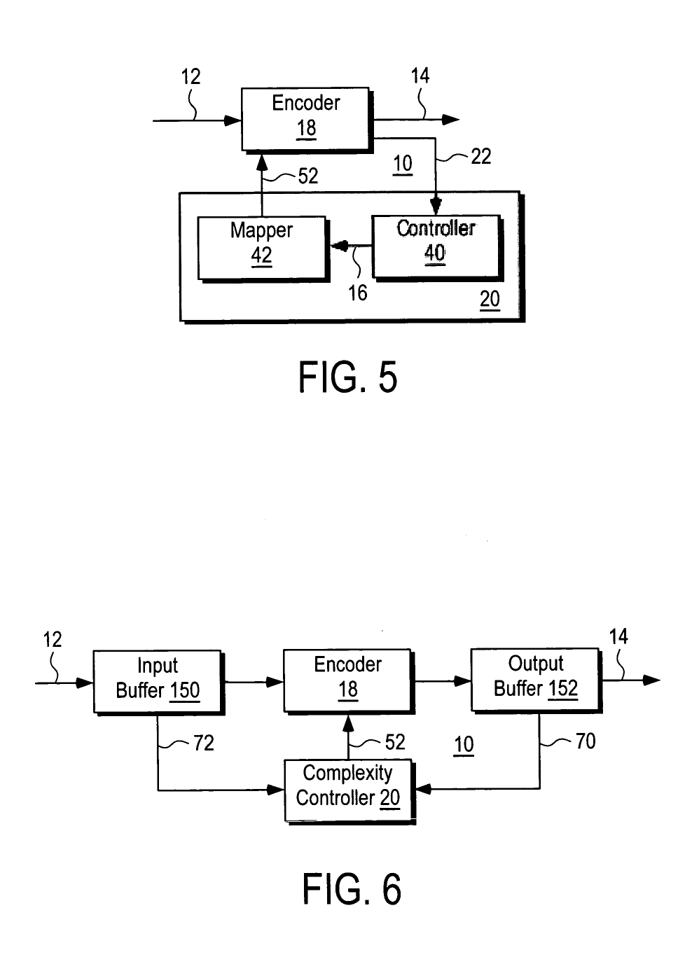

FIG. 5 shows a controller 40 and a mapper 42 in one embodiment of the complexity controller 20. The controller 40 generates a scaled complexity control value 16 in response to the timing signal 22. The mapper 42 maps the scaled complexity control value 16 into the complexity control parameters 52 that control fast motion estimation on a macro-block level in the video encoder 10.

A training based method may be used to determine a mapping of the scaled complexity control value 16 to the complexity control parameters 52. A training method may include creating a pool of rate-complexity (R-C) points at a constant distortion based on a large training video and finely sampling the appropriate parameters. The R-C points not on the convex hull are pruned out and from the remaining R-C points the optimal parameter combination for a given complexity value are read out.

The complexity controller 20 provides a feedback control loop for controlling the encoding time of the video encoder 10 per macro-block. The scaled complexity control value 16 (C_{S}) is updated in response to a deviation from a target encoding time using a sliding window of previous M macro-blocks according to the following.

$${C}_{S} [ i ] = {C}_{S} [ i - 1 ] + {K}_{p} e [ i - 1 ] + {K}_{D} ( e [ i - 1 ] - e [ i - 2 ] ) , \\ e [ i ] = {\sum }_{k = 0}^{M - 1} ( c [ i - k ] - {C}_{T} ) ,$$

where c is the real encoding time for each macro-block measured with an accurate timer and C_{T} is the target encoding time per macro-block. K_{P} and K_{D} are proportional and derivative constants.

The mapper 42 maps the C_{S} for each macro-block to the complexity control parameters 52 before encoding. The target encoding time per any unit, e.g. a video frame or group of video frames. A similar mechanism may be used for joint complexity-rate control in real time coding and transmission systems where the delay and buffer constraints are satisfied with relatively little fluctuations in quality.

FIG. 6 shows the video encoder 10 enforcing a buffering constraint. The encoder 18 obtains macro-blocks from an input buffer 150 and fills an output buffer 152 for the video signal 14. The complexity controller 20 obtains a buffer fullness signal 72 (B₁ (i)) from the input buffer 150 and a buffer fullness signal 70 (B₂ (i)) from the output buffer 152. The complexity control 20 meets buffering constraints associated with the input buffer 150 and the output buffer 152 by updating the complexity control parameters 52 in response to the buffer fullness signals 70 and 72 as follows.

$${C}_{S} ( i ) = {C}_{S} ( i - 1 ) + {μ}_{1 \_c} \{ {B}_{1} ( i ) - \frac{{B}_{1 max}}{2} \} + {μ}_{2 \_c} \{ {B}_{2} ( i ) - \frac{{B}_{2 max}}{2} \}$$

The rate-distortion slope is updated as follows.

$${λ}_{R} ( i ) = {λ}_{R} ( i - 1 ) + {μ}_{1 \_R} \{ {B}_{1} ( i ) - \frac{{B}_{1 max}}{2} \} + {μ}_{2 \_R} \{ {B}_{2} ( i ) - \frac{{B}_{2 max}}{2} \}$$

where B₁ (i) and B₂ (i) are the fullness of the input buffer 150 and the output buffer 152 at time i and B₁ₘₐₓ and B₁ₘₐₓ are the maximum buffer sizes and μ₁_{_{—}}_{C} and μ₂_{_{—}}_{C} and μ₁_{_{—}}_{R} and μ₂_{_{—}}_{R} are appropriate step sizes.

The process of fine-grained complexity scaling in the video encoder 10 is based on an observation that a majority of the complexity in transform-based motion-compensated video encoders involves the motion estimation with mode search, along with transform and entropy coding. Most of the complexity may be attributed to the motion estimation (ME) and mode decision steps in the video encoder 10 even when a fast ME scheme is used. The complexity controller 20 allocates the total available complexity, e.g. per frame, optimally and differently to constituent macro-blocks.

The complexity control parameters 52 are selected to scale the complexity of motion/mode search in the video encoder 10 in the context of a fast ME process. In one embodiment, the complexity control parameters 52 include a mode gradient (λ_{MD}) for the number of modes searched, a motion estimation gradient (λ_{ME}) for motion vector accuracy, and an early stop SAD threshold (β). The complexity control parameters 52 may be scaled in combination to achieve the best rate-distortion tradeoff for a given complexity.

The early stop SAD threshold (β) comes into play during the mode and motion search by the video encoder 10. The early stop criterion terminates the search and the best mode and motion vectors obtained up to that point are used as the decision for the corresponding macro-block. This is done by comparing the best SAD cost so far against the early stop SAD threshold. The early stop SAD threshold is obtained by SAD cost prediction from neighboring blocks for the 16×16 case and the SAD cost value for the next higher block size for smaller sizes of macro-blocks. The SAD cost threshold is scaled from the original prediction using the early stop SAD threshold (β) as follows.

SAD_Early_Stop_{—}Th=β(SAD cost prediciton)

The motion estimation gradient (λ_{ME}) is defined as follows.

$${λ}_{ME} = \frac{Δ SAD}{Δ \text{computation}}$$

where ΔSAD is the SAD cost difference between before and after that ME step is performed and Δcomputation is the computation required to perform that step which can be the number of SAD cost computations per pixel or real time required. When λ_{ME} is smaller than a gradient threshold (λ_{ME}_{_{—}}TH), the motion estimation process stops. The same procedure is also applied to sub-pixel motion estimation.

A method of scaling complexity using the motion estimation gradient (λ_{ME}) and SAD cost threshold (SAD_Th) is as follows.

Step A1: For each macro-block.

Step A2: Check the SAD cost of the predictors to find the best possible initial search point.

Step A3: If SAD<SAD_Th go to step A5. Otherwise, do an unsymmetrical Cross Search.

Step A4: If SAD<SAD_Th go to step A5. Otherwise, do big hexagon search.

Step A5: Conduct one step in the recursive small hexagon search loop.

Step A6: If

$${λ}_{ME} = \frac{Δ SAD}{Δ \text{computation}} < {λ}_{ME} \_TH$$

or if ΔSAD=0, go to step A8. Otherwise repeat step A5.

Step A7: Conduct one step in the recursive diamond search loop.

Step A8: If

$${λ}_{ME} = \frac{Δ SAD}{Δ \text{computation}} < {λ}_{ME} \_TH$$

or if ΔSAD=0, stop. Otherwise repeat step A7.

A method of scaling sub-pixel complexity using the motion estimation gradient (λ_{ME}) is as follows.

Step B1: For every (interpolated) macro-block.

Step B2: Conduct one step in the recursive hexagonal search loop, by computing SADs with respect to interpolated reference.

Step B3: If

$${λ}_{ME} = \frac{Δ SAD}{Δ \text{computation}} < {λ}_{ME} \_TH$$

or if ΔSAD=0, stop. Otherwise repeat step B2.

The mode gradient (λ_{MD}) is defined as follows.

$${λ}_{MD} = \frac{Δ SAD}{Δ \text{computation}}$$

where ΔSAD is the SAD cost difference between before and after that mode search step is performed and Δcomputation is the computation required to perform that mode which can be the number of SAD computations per pixel or real time consumed. When λ_{MD} is smaller than gradient threshold (λ_{—}_{_{—}}TH), the mode decision process stops.

The encoder 10 searches a fixed number of a set of selected modes sequentially until a stopping criteria is satisfied. Alternatively, the encoder 10 may search only 16×16, 16×8, and 8×16 modes. The stopping criterion may be based on a threshold in the cost function or the mode gradient λ_{MD}.

The order in which the encoder 10 searches modes may be based on statistical frequency of the modes for a given training set. Alternatively, the order may be based on low complexity features computed from a video. The dependencies in the INTER mode group from motion vector and SAD predictors require searching in-order from larger to smaller sizes even though the search may terminate anywhere within that group.

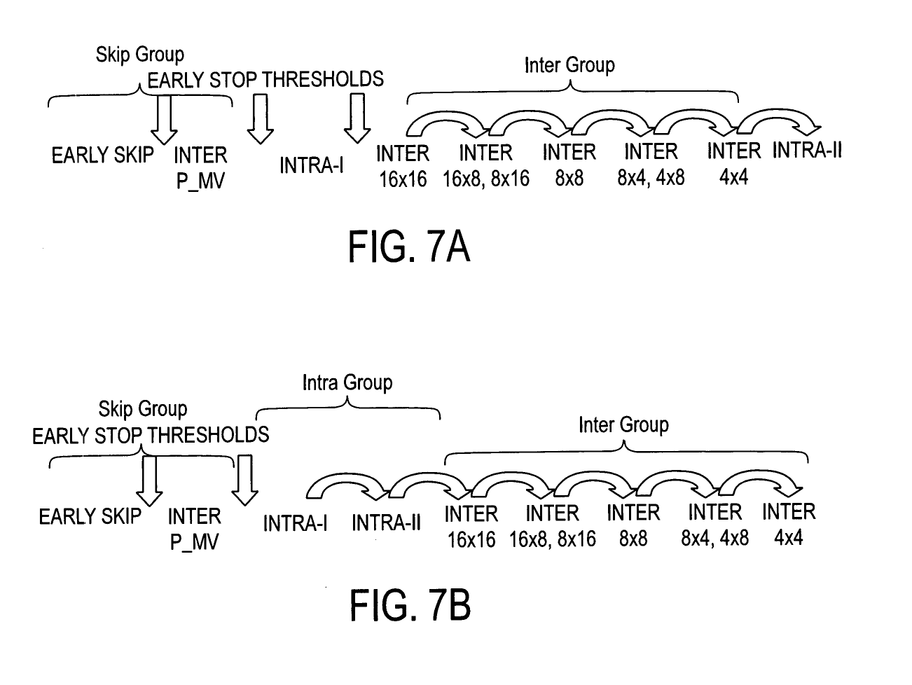

FIG. 7a shows an example ordered mode search for relatively low resolution video. FIG. 7b shows an example ordered mode search for relatively high resolution video. For higher resolution video, the ordering changes because intra prediction modes become more efficient than inter modes, and hence

Step C6: Find SAD_cost for 8×16 and 16×8 modes, if

$${λ}_{MD} = \frac{SAD ( 16 \times 16 ) - min ( SAD ( 16 \times 8 ) , SAD ( 8 \times 16 ) )}{Δ \text{computation}} < {λ}_{MD} \_TH$$

then set mode=Inter16×8 (or 8×16) and go to step C13, else go to step C7.

Step C7: For each 8×8 block,

Step C8: Find SAD_cost for 8×8 mode, if

$${λ}_{MD} = \frac{SAD\_pred ( 8 \times 8 ) - ( SAD ( 8 \times 8 )}{Δ \text{computation}} < {λ}_{MD} \_TH$$

then go to step C11, else go to step C9.

Step C9: Find SAD_cost for 4×8 and 8×4 modes, if

$${λ}_{MD} = \frac{SAD ( 8 \times 8 ) - min ( SAD ( 4 \times 8 ) , SAD ( 8 \times 4 ) )}{Δ \text{computation}} < {λ}_{MD} \_TH$$

then to step C11, else go to step C10.

Step C10: Find SAD_cost for 4×4 mode, if

$${λ}_{MD} = \frac{min ( SAD ( 4 \times 8 ) , SAD ( 8 \times 4 ) - SAD ( 4 \times 4 ) )}{Δ \text{computation}} < {λ}_{MD} \_TH$$

then to step C11, else go to step C12.

Step C11: Set mode of the 8×8 block, if all 8×8 block modes are set go to step C12, else go to step C7 for the next 8×8 block.

Step C12: Find Intra-cost for the macro-block with predictions, select the mode with minimum intra modes should be tested earlier. The INTRA-II group includes a variety of predictors and complexity scaling may be performed by ordering the search within the predictors as well, particularly for high definition content in a video.

A method of scaling complexity using the mode gradient (λ_{MD})is as follows.

Step C1: For every macro-block.

Step C2: Find Skip mode SAD_cost(SAD(Skip)), if SAD(Skip)<SAD_Early_Skip_Th then set mode=skip, go to step C13, else go to step C3.

Step C3: If SAD(Skip)<SAD_Early_Skip_Th, then set MV=MV pred, mode=Inter16×16, go to step C13, else go to step C4.

Step C4: Find Intra-cost(SAD(intra)), if SAD(intra)<SAD_Early_Skip_Th, then set mode=intra, go to step C13, else go to step C5.

Step C5: Find SAD_cost for 16×16 mode (SAD (16×16) ), if

$${λ}_{MD} = \frac{SAD ( Skip ) - SAD ( 16 \times 16 )}{Δ \text{computation}} < {λ}_{MD} \_TH$$

then set mode=Inter16×16 and go to step C13, else go to step C6. SAD_cost. Step C13: Encode macro-block with given mode.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A method for encoding a video, comprising:
scaling a set of complexity control parameters in response to an encoding constraint;
encoding the video in response to the complexity control parameters.

2. The method of claim 1, wherein scaling comprises scaling in response to a bit rate constraint.

3. The method of claim 1, wherein scaling comprises scaling in response to an encoding time constraint.

4. The method of claim 1, wherein scaling comprises scaling in response to a rate-complexity constraint.

5. The method of claim 1, wherein scaling comprises scaling in response to a buffering constraint.

6. The method of claim 1, wherein scaling comprises:
determining a complexity control value in response to the encoding constraint;
mapping the complexity control value to the complexity control parameters in response to a training set.

7. The method of claim 1, wherein scaling comprises scaling a mode search parameter for fast motion estimation.

8. The method of claim 1, wherein scaling comprises scaling a parameter for motion estimation accuracy.

9. The method of claim 1, wherein scaling comprises scaling an early stop parameter for a fast motion estimation mode search.

10. The method of claim 1, wherein encoding the video comprises performing a fast motion estimation mode search in a predetermined order.

11. A video encoder, comprising:
complexity controller that scales a set of complexity control parameters in response to an encoding constraint;
encoder that encodes a video in response to the complexity control parameters.

12. The video encoder of claim 11 wherein the encoding constraint is a bit rate constraint.

13. The video encoder of claim 11, wherein the encoding constraint is an encoding time constraint.

14. The video encoder of claim 11, wherein the encoding constraint is a rate-complexity constraint.

15. The video encoder of claim 11, wherein the encoding constraint is a buffering constraint.

16. The video encoder of claim 11, wherein the complexity control parameters include a mode gradient parameter for determining when to terminate a mode search having a pre-determined order.

17. The video encoder of claim 11, wherein the complexity control parameters include a parameter for motion estimation accuracy.

18. The video encoder of claim 11, wherein the complexity control parameters include an early stop threshold parameter for determining whether a mode and motion search should be terminated early.

19. The video encoder of claim 11, wherein the encoder performs a fast motion estimation mode search in a predetermined order.

20. The video encoder of claim 11, wherein the complexity control parameters include a number of modes parameter indicating an actual number of modes to be searched in a pre-determined order.
